(19) United States
(12) Patent Application Publication
(10) Pub. No.: US 2007/0182477 A1
(43) Pub. Date: Aug. 9, 2007

(54) Band gap reference circuit for low voltage and semiconductor device including the same

(75) Inventor: You Sung Kim, Seoul (KR)

Correspondence Address: MAYER, BROWN, ROWE & MAW LLP, 1909 K STREET, N.W., WASHINGTON, DC, 20006, US

(73) Assignee: Hynix Semiconductor Inc.

(21) Appl. No.: 11/485,276

(22) Filed: Jul. 13, 2006

(30) Foreign Application Priority Data
Feb. 5, 2006 (KR) 2006-39466

(51) Int. Cl. G05F 1/10

(52) U.S. Cl. 327/539

(57) ABSTRACT

A band gap reference circuit and a semiconductor device including the band gap reference circuit. The band gap reference circuit comprises a comparator, a first current source circuit, a second current source circuit, a first load circuit, and a second load circuit. The comparator compares a first voltage and a second voltage and outputs a control voltage according to the comparison result. The first current source circuit supplies a first current to a first node in response to the control voltage. The second current source circuit supplies a second current to a second node in response to the control voltage. The first load circuit generates first and second voltages determined by the first current received through the first node and the resistance value thereof. A second load circuit generates a reference voltage determined by the second current received through the second node and the resistance value thereof. The band gap reference circuit and the semiconductor device including the band gap reference circuit can be stably operated even when a low power source voltage is supplied.

### BACKGROUND OF THE INVENTION

1. Field of the Invention

The present invention relates to a semiconductor device, and more particularly to a band gap reference circuit and a semiconductor device including the band gap reference circuit.

2. Description of the Prior Art

It is important for a reference voltage generator to generate a stable reference voltage rarely influenced by a temperature change in order to stably operate a semiconductor device including the reference voltage generator. Therefore, a band gap reference circuit which, as is well known, can generate a very stable and accurate reference voltage even when the temperature is changed is mainly used as the reference voltage generator. Conventionally, since a formula of a reference voltage generated by a band gap reference circuit includes a negative temperature coefficient and a positive temperature coefficient, which is opposite to and offset by each other, the variation factor of the reference voltage according to a temperature change can decrease. Therefore, the band gap reference circuit can generate a reference voltage of a voltage level which is always stable even when the temperature is changed. FIG. 1 shows waves of reference voltages generated by a conventional band gap reference circuit. Referring to FIG. 1, as the power source voltage supplied to the band gap reference circuit as an operation power source is changed, the reference voltage is also changed so as to exist in the range between the voltages VF1 and VF1. However, the conventional band gap reference circuit may not be normally operated if a power source voltage is of a low voltage (for example, of less than 1.3 V). This is because the total sum of the minimum voltages dropped by the interior circuits constituting the band gap reference circuit is larger than the power source voltage of the low voltage.

### SUMMARY OF THE INVENTION

Accordingly, the present invention has been made to solve the above-mentioned problems occurring in the prior art, and an object of the present invention is to provide a band gap reference circuit for a low voltage, which can be normally operated to generate a stable reference voltage even when a low power source voltage is supplied.

It is another object of the present invention to provide a semiconductor device including a band gap reference circuit for a low voltage, which can be normally operated to generate a stable reference voltage even when a low power source voltage is supplied.

In order to accomplish this object, according to a preferred embodiment of the present invention, there is provided a band gap reference circuit comprising a comparator, a first current source circuit, a second current source circuit, a first load circuit, and a second load circuit. The comparator compares a first voltage and a second voltage and outputs a control voltage according to the comparison result. The first current source circuit supplies a first current to a first node in response to the control voltage. The second current source circuit supplies a second current to a second node in response to the control voltage. The first load circuit generates first and second voltages determined by the first current received through the first node and the resistance value thereof. A second load circuit generates a reference voltage determined by the second current received through the second node and the resistance value thereof.

According to one aspect of the present invention, there is provided a low voltage semiconductor device comprising a band gap reference circuit, an interior voltage generator, and an interior circuit. The band gap reference circuit generates a reference voltage insensitive to a temperature change on the basis of a power source voltage. Preferably, the band gap reference circuit comprises a comparator, a first current source circuit, a second current source circuit, a first load circuit, and a second load circuit. The comparator compares a first voltage and a second voltage and outputs a control voltage according to the comparison result. The first current source circuit supplies a first current to a first node in response to the control voltage. The second current source circuit supplies a second current to a second node in response to the control voltage. The first load circuit generates first and second voltages determined by the first current received through the first node and the resistance value thereof. The second load circuit generates a reference voltage determined by the second current received through the second node and the resistance value thereof. The interior voltage generator generates an interior voltage on the basis of the reference voltage. The interior circuit uses the interior voltage as an operation power source and is operated when the interior voltage is supplied.

According to another aspect of the present invention, there is provided a low voltage semiconductor device comprising a band gap reference circuit, an interior voltage generator, a detector, and an interior circuit. The band gap reference circuit generates a reference voltage insensitive to a temperature change on the basis of a power source voltage. Preferably, the band gap reference circuit comprises a comparator, a first current source circuit, a second current source circuit, a first load circuit, and a second load circuit. The comparator compares a first voltage and a second voltage and outputs a control voltage according to the comparison result. The first current source circuit supplies a first current to a first node in response to the control voltage. The second current source circuit supplies a second current to a second node in response to the control voltage. The first load circuit generates first and second voltages determined by the first current received through the first node and the resistance value thereof. The second load circuit generates a reference voltage determined by the second current received through the second node and the resistance value thereof. The interior voltage generator generates an interior voltage. The detector detects whether the interior voltage is different from the reference voltage and outputs a detection signal according to the detection result. The interior circuit uses the interior voltage as an operation power source and is operated when the interior voltage is supplied. Preferably, the interior voltage generator increases or decreases the interior voltage according to the detection signal

### BRIEF DESCRIPTION OF THE DRAWINGS

The above and other objects, features and advantages of the present invention will be more apparent from the following detailed description taken in conjunction with the accompanying drawings, in which:

FIG. 1 is a wave view showing reference voltages generated by a conventional band gap reference circuit;

FIG. 2 is a view showing a band gap reference circuit according to an embodiment of the present invention;

FIG. 3 is a wave view showing reference voltages generated by the band gap reference circuit shown in FIG. 2 according to an embodiment of the present invention;

FIG. 4 is a view showing a semiconductor device according to an embodiment of the present invention; and

FIG. 5 is a view showing a semiconductor device according to another preferred embodiment of the present invention.

### DETAILED DESCRIPTION OF THE PREFERRED EMBODIMENTS

Hereinafter, embodiments of the present invention will be described in detail with reference to the accompanying drawings. However, it should be noted that the present invention is not limited to the embodiments but can be realized in various types and the embodiments are provided to complete the disclosure of the present invention and to fully inform those skilled in the art of the category of the present invention.

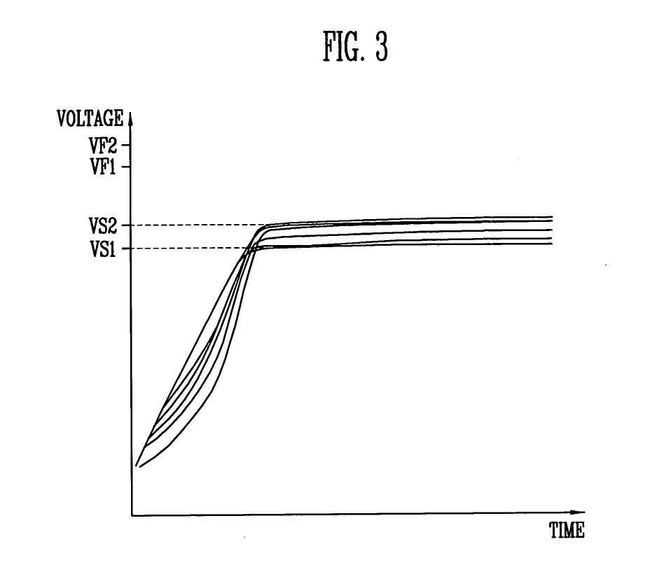

FIG. 3 is a view showing a band gap reference circuit according to a preferred embodiment of the present invention. Referring to FIG. 3, the band gap reference circuit 100 includes a comparator 110, a first current source circuit PM1, a second current source circuit PM2, a first load circuit 120, and a second load circuit R16. The comparator 110 compares voltages V1 and V2 and outputs a control voltage VCOM according to the comparison result. Preferably, the comparator 110 can be realized by an amplifier. Hereinafter, the comparator 110 is referred to as an amplifier. The amplifier 110 amplifies the voltage difference between the voltages V1 and V2 and outputs the amplified voltage as the control voltage VCOM. More particularly, the voltage V2 is input to a noninverting input terminal (+) of the amplifier 110 and the voltage V1 is input to an inverting input terminal (−) of the amplifier 110. The amplifier 110 increases the control voltage VCOM if the voltage V2 is higher than the voltage V1. Further, the amplifier 110 decreases the control voltage VCOM if the voltage V1 is higher than the voltage V2. The first current source circuit PM1 supplies a current I10 to a node N1 in response to the control voltage VCOM. The second current circuit PM2 supplies a current I40 to a node N4 in response to the control voltage VCOM. Preferably, each of the first and second current source circuits PM1 and PM2 can be realized by PMOS transistors. Hereinafter, each of the first and second current source circuits PM1 and PM2 is referred to as a PMOS transistor. A power source voltage VDD is input to the sources of the PMOS transistors PM1 and PM2 and the control voltage VCOM is input to the gates thereof. Further, the drain of the PMOS transistor PM1 is connected to the node Ni and the drain of the PMOS transistor PM2 is connected to a node N2. The first load circuit 120 includes resistances R11 to R15 and transistors B0 to BN (N is an integer). The resistance R11 is connected between the nodes N1 and N3 and the resistance R12 is connected between the nodes N1 and N4. Preferably, the resistance values of the resistances R11 and R12 can be set so as to be identical. When the PMOS transistor PM1 supplies the current I10 to the node N1, the current I10 is divided into currents I20 and I30 which flow through the resistances R11 and R12, respectively. In other words, the sum of the currents I20 and I30 is identical with the current I10. On the other hand, when the PMOS transistor PM1 supplies the current I10 to the node N1, an interior reference voltage VREFO determined by the resistance value of the first load circuit 120 and the current I10 is generated in the node N1. The resistance R13 is connected between the node N3 and a ground terminal and the resistance R14 is connected between the node N4 and the ground terminal. Preferably, the resistance values of the resistances R13 and R14 can be set so as to be identical. When the current I20 is supplied to the node N3, the current I20 is divided into currents I21 and I22 which flow through the transistor B0 and the resistance R13, respectively. In other words, the sum of the currents I21 and I22 is identical with the current I20. The voltage V1 determined by the current I22 and the resistance value of the resistance R13 is generated in the node N3. Further, when the current I30 is supplied to the node N4, the current I30 is divided into currents I31 and I32 which flow through the transistors B1 to BN and the resistance R14, respectively. In other words, the sum of the currents I31 and I32 is identical with the current I30. The voltage V2 determined by the current I32 and the resistance R14 is generated in the node N4. One side terminal of the resistance R15 is connected to the node N4 in parallel to the resistance R14. The resistance value of the resistance R14 can be set so as to be higher than the resistance value of the resistance R15. Preferably, each of the transistors B0 to BN can be realized by a bipolar junction transistor. In this case, the emitter of the transistor B0 is connected to the node N3 and the collector and the base thereof are connected to the ground terminal. The transistors B1 to BN are connected between the node N4 and the ground terminal in parallel to one another. More particularly, the emitters of the transistors B1 to BN are connected to the other side terminal of the resistance R15 and the bases and the collectors thereof are connected to the ground terminal. The transistors B0 to BN are operated in response to the ground voltage. The second load circuit R16 can be realized by a resistance connected between the node N2 and the ground terminal. Hereinafter, the second load circuit R16 is referred to as a resistance.

Next, the operation of the band gap reference circuit 100 will be described in detail. First, the comparator 110 initially outputs the control voltage VCOM in a logic low. As the power source voltage VDD supplied to the band gap reference circuit 100 increases, the PMOS transistors PM1 and PM2 supply the currents 110 and I40 to the nodes N1 and N2 in response to the control voltage VCOM. The current I10 is divided into the currents I20 and I30 which flow through the resistances R11 and R12 of the first load circuit 120, respectively and are supplied to the nodes N3 and N4. The current I20 is divided into the currents I21 and I22 which flow through the transistor B0 and the resistance R13, respectively. The current I30 is divided into the currents I31 and I32 which flow through the transistors B1 to BN and the resistance R14, respectively. The voltage V1 determined by the current I22 and the resistance R13 is generated in the node N3 and the voltage V2 determined by the current I32 and the resistance R14 is generated in the node N4. Here, the resistance values of the resistances R11 and R12 are set so as to be identical and the resistance values of the resistances R13 and R14 are set so as to be identical. The comparator 110 compares the voltages V1 and V2 and increase or decreases the control voltage VCOM on the basis of the comparison result. As a result, the PMOS transistors PM1 and PM2 increase or decrease the currents I10 and I40 in response to the control voltage VCOM. As the control voltage VCOM decreases, the PMOS transistors PM1 and PM2 increase the currents I10 and I40. Further, as the control voltage VCOM increases, the PMOS transistors PM1 and PM2 decrease the currents I10 and I40. The comparator 110 regulates the current driving capacity of the PMOS transistor PM1 so that the voltages V1 and V2 can be identical.

For example, if the voltage V1 is higher than the voltage V2, the potential difference between both side terminals of the resistance R12 becomes larger than the potential difference between both side tenninals of the resistance R11. On the other hand, if the voltage V1 is higher than the voltage V2, the comparator 110 decreases the control voltage VCOM. As a result, the PMOS transistor PM1 increases the current I10. Then, since the potential difference between the terminals of the resistance R12 is larger than the potential difference between the terminals of the resistance R11, the current I30 flowing through the resistance R12 becomes higher than the current I30. As a result, the voltage V2 increases. Further, if the voltage V2 is higher than the voltage V1, the potential difference between the terminals of the resistance R11 becomes larger than the potential difference between the terminals of the resistance R12. On the other hand, if the voltage V2 is higher than the voltage V1, the comparator 110 increases the control voltage VCOM. As a result, the PMOS transistor PM1 decreases the current I10. Then, since the potential difference between the terminals of the resistance R11 is larger than the potential difference between the terminals of the resistance R12, the current I20 flowing through the resistance R11 becomes higher the current I30. As a result, the voltage V1 increases. The band gap reference circuit 100 repeats the above-mentioned operation until the voltages V1 and V2 become identical.

On the other hand, when the voltages V1 and V2 are identical, the interior reference voltage VREFO generated in the node N1 can be expressed in Formula 1 below.

$$\begin{matrix}VREF 0 = {V}_{BE 1} + {V}_{R 11} \\ = {V}_{BE 1} + ( I 20 \times R 11 )\end{matrix} \qquad Formula 1$$

In Formula 1, V_{BE1} is a voltage dropped to transistor B0. Since the resistance values of the resistances R11 and R12 are identical, if the voltages V1 and V2 become indentical, the currents I20 and I30 also become identical. Therefore, the interior reference voltage VREFO can be expressed in Formula 2 below, by using the current I30.

$$\begin{matrix}VREF 0 = {V}_{BE 1} + I 30 \times R 11 \\ = {V}_{BE 1} + ( I 31 + I 32 ) \times R 11\end{matrix} \qquad Formula 2$$

The currents I31 and I32 can be expressed in Formula 3 below.

$$I 31 = ( \frac{{V}_{BE 1} - {V}_{BE 2}}{R 15} ) , \\ I 32 = \frac{{V}_{BE 1}}{R 14} \\ ( here , {V}_{BE 1} - {V}_{BE 2} = {V}_{T} ln ( N \times \frac{R 12}{R 11} ) , {V}_{T} = \frac{K \times T}{q} ) \qquad Formula 3$$

In Formula 3, V_{BE2} is a voltage dropped to the transistors B1 to BN. V_{T} is the thermal voltage, K is the Boltzmann'constant, T is the absolute temperature, and q is the electric charge. Further, N is the area ratio of the transistor B0 and the transistors B1 to BN connected in parallel to the node N5. In other words, N is a value obtained by dividing the entire area of the transistors B1 to BN by the area of the transistor B0. Consequently, N is equal to the number of the transistors B1 to BN. If Formula 3 is substituted for Formula 2, the interior reference voltage VREFO can be expressed in Formula 4 below.

$$\begin{matrix}VREF 0 = {V}_{BE 1} + ( \frac{{V}_{BE 1} - {V}_{BE 2}}{R 15} + \frac{{V}_{BE 1}}{R 14} ) \times R 11 \\ = {V}_{BE 1} + ( \frac{VT ln ( N \times \frac{R 12}{R 11} )}{R 15} + \frac{{V}_{BE 1}}{R 14} ) \times R 11\end{matrix} \qquad Formula 4$$

In Formula 4, since the resistance values of the resistances R11 and R12 are identical, “R12/11” can be offset. As a result, the interior reference voltage VREFO can be expressed in Formula 5 below.

$$\begin{matrix}VREF 0 = {V}_{BE 1} + ( \frac{{V}_{T} ln ( N )}{R 15} + \frac{{V}_{BE 1}}{R 14} ) \times R 11 \\ = {V}_{BE 1} + \frac{R 11}{R 15} {V}_{T} ln ( N ) + \frac{R 11}{R 14} {V}_{BE 1} \\ = ( 1 + \frac{R 11}{R 14} ) {V}_{BE 1} + \frac{R 11}{R 14} {V}_{T} ln ( N )\end{matrix} \qquad Formula 5$$

On the other hand, since the PMOS transistor PM2 is operated in response to the control voltage VCOM, the current I40 identical with the current I10 is supplied to the node N2. As a result, the reference voltage VREF1 determined by the current I40 and the resistance R16 is generated in the node N2. Then, the reference voltage VREF1 can be expressed in Formula 6 below.

$$\begin{matrix}VREF 1 = I 40 \times R 16 \\ = I 10 \times R 16 \\ = ( I 20 + I 30 ) \times R 16\end{matrix} \qquad Formula 6$$

If the voltages V1 and V2 become indentical, since the currents I20 and I30 also become identical, the reference voltage VREF1 can be expressed in Formula 7 below.

$$\begin{matrix}VREF 1 = 2 I 30 \times R 16 \\ = 2 ( I 31 + I 32 ) \times R 16\end{matrix} \qquad Formula 7$$

If Formula 3 is substituted for Formula 7, the reference voltage VREF1 can be expressed in Formula 8 below.

$$\begin{matrix}VREF 1 = 2 ( \frac{{V}_{BE 1} - {V}_{BE 2}}{R 15} + \frac{{V}_{BE 1}}{R 14} ) \times R 16 \\ = 2 ( \frac{{V}_{T} ln ( N \times \frac{R 12}{R 11} )}{R 15} + \frac{{V}_{BE 1}}{R 14} ) \times R 16\end{matrix} \qquad Formula 8$$

Since the resistance values of the resistances R11 and R12 are identical, “R12/R11” can be offset in Formula 8. As a result, the reference voltage VREF1 can be expressed in Formula 9 below.

$$\begin{matrix}VREF 1 = 2 ( \frac{{V}_{T} ln ( N )}{R 15} + \frac{{V}_{BE 1}}{R 14} ) \times R 16 \\ = \frac{2 R 16}{R 14} ( {V}_{BE 1} + \frac{R 14}{R 15} \times {V}_{T} ln ( N ) )\end{matrix} \qquad Formula 9$$

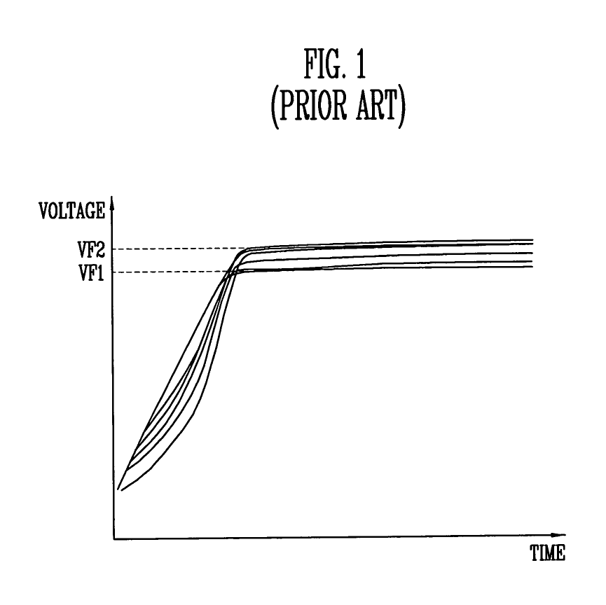

In Formula 9, “V_{BE1}” is a negative temperature coefficient and “(R14/R15)×V_{T}ln(N)” is a positive temperature coefficient. Since the variation factor of the reference voltage VREF1 according to the temperature change is compensated for by the temperature coefficients, the band gap reference circuit 100 can generate the reference voltage VREF1 of a voltage level which is always stable, in spite of the temperature change. The minimum value of the V_{BE1} is about 0.8V. On the other hand, since the ratio of the resistance values of the resistances R14 and R15 is fixed to about 11 for the stable operation of the band gap reference circuit 100, the value of “R14/R15×V_{T}ln(N)” is fixed. Consequently, in Formula 9, the minimum value of “V_{BE1}+R14/R15×V_{T}ln(N)” is fixed. However, when the ratio of the resistance values of the resistances R16 and R14 are regulated, the reference voltage VREF1 can decrease further. FIG. 3 shows waves of the reference voltages VREF1 generated by the band gap reference circuit 100 when the power source voltage VDD is changed. Referring to FIG. 3, the reference voltages VREF1 exist in a range between the voltages VS2 and VS1 lower than the voltage VF1. Consequently, it can be understood that the reference voltage VREF1 decreases further as compared with the reference voltage shown in FIG. 1.

Since the reference voltage VREF1 can decrease when the ratio of the resistance values of the resistances R16 and R14 is regulated, even if a low power source voltage VDD (for example, of less than 1.3V) is supplied to the band gap reference circuit, the band gap reference circuit 100 can be normally operated. Here, the power source voltage VDD can be expressed in Formula 10 below, by using Formula 9.

$$\begin{matrix}VDD = {V}_{DS} + VREF 1 \\ = {V}_{DS} + \frac{2 R 16}{R 14} ( {V}_{BE 1} + \frac{R 14}{R 15} \times {V}_{T} ln ( N ) )\end{matrix} \qquad Formula 10$$

In Formula 10, V_{DS} is the difference between the voltages of the drain and the source of the PMOS transistor PM2.

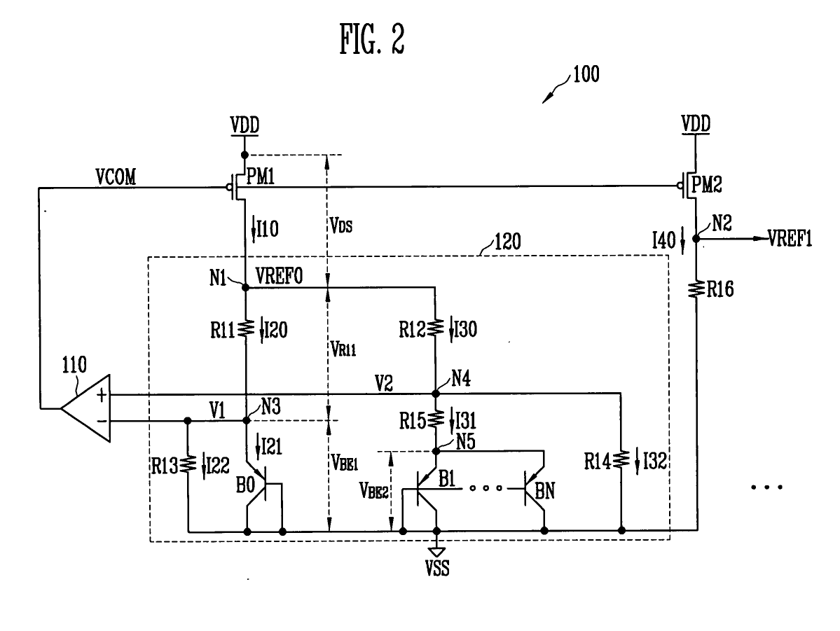

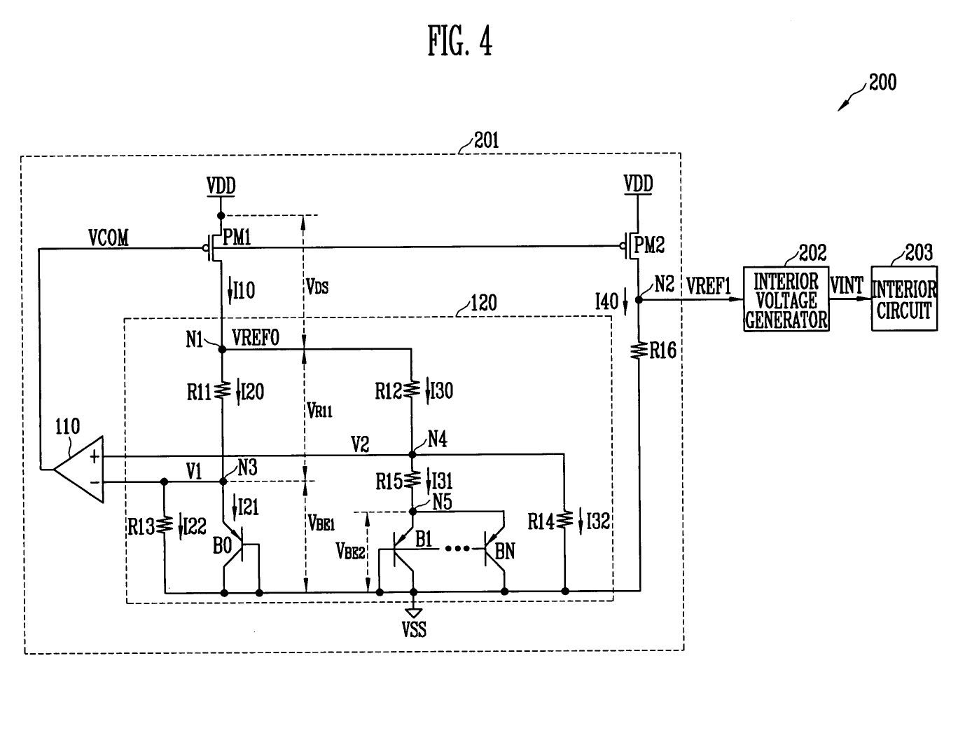

FIG. 4 is a view showing a semiconductor device according to a preferred embodiment of the present invention. Referring to FIG. 4, the semiconductor device 200 includes a band gap reference circuit 210, an interior voltage generator 202, and an interior circuit 203. The band gap reference circuit 201 generates a reference voltage VREF1 insensitive to the temperature change on the basis of a power source voltage VDD. The constitution and the detailed operation of the band gap reference circuit 201 are substantially the same as the constitution and the operation of the band gap reference circuit 100 described with reference to FIG. 2. Therefore, in order to avoid the repetition of the explanation, the constitution and the detailed operation of the band gap reference circuit 201 will be omitted. The interior voltage generator 202 generates an interior voltage VINT on the basis of the reference voltage VREF1. Then, the interior voltage generator 202 can generate the interior voltage VINT identical with or different from the reference voltage VREF. The interior circuit 203 uses the interior voltage VINT as an operation power source, and is operated when the interior voltage VINT is supplied. The semiconductor device 200 may include a semiconductor memory or an interior voltage generator.

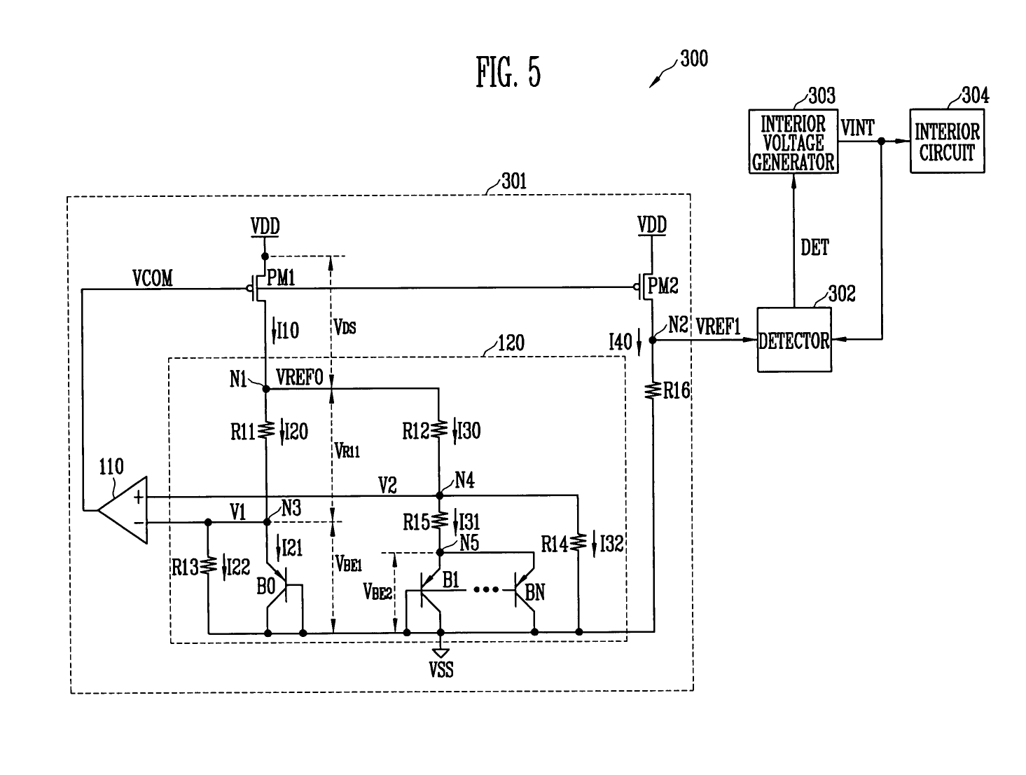

FIG. 5 is a view showing a semiconductor device according to another preferred embodiment of the present invention. Referring to FIG. 5, the semiconductor device 300 includes a band gap reference circuit 301, a detector 302, an interior voltage generator 303, and an interior circuit 304. The band gap reference circuit 301 generates a reference voltage VREF1 insensitive to the temperature change on the basis of a power source voltage VDD. The constitution and the detailed operation of the band gap reference circuit 301 are substantially the same as the constitution and the operation of the band gap reference circuit 100 described with reference to FIG. 2. Therefore, in order to avoid the repetition of the explanation, the constitution and the detailed operation of the band gap reference circuit 201 will be omitted. The detector 302 detects whether the interior voltage VINT is different from the reference voltage VREF1 and outputs a detection signal DET according to the detection result. The interior voltage generator 303 generates the interior voltage VINT and increases or decreases the interior voltage VINT in response to the detection signal DET. For example, if the interior voltage VINT is higher than the reference voltage VREF1, the detector 302 outputs the detection signal DET so that the interior voltage generator 303 decreases the interior voltage VINT. Further, if the interior voltage VINT is lower than the reference voltage VREF1, the detector 302 outputs the detection signal DET so that the interior voltage generator 303 increases the interior voltage VINT. The interior circuit 304 uses the interior voltage VINT as an operation power source and is operated when the interior voltage VINT is supplied.

As mentioned above, the band gap reference circuit and the semiconductor device including the band gap reference circuit can be stably operated even when a low power source voltage is supplied.

Although embodiments of the present invention have been described for illustrative purposes, those skilled in the art will appreciate that various modifications, additions and substitutions are possible, without departing from the scope and spirit of the invention as disclosed and claimed in the accompanying claims.

What is claimed is:

1. A band gap reference circuit comprising:
a comparator comparing a first voltage and a second voltage and outputting a control voltage according to the comparison result;
a first current source circuit supplying a first current to a first node in response to the control voltage;
a second current source circuit supplying a second current to a second node in response to the control voltage;
a first load circuit generating first and second voltages determined by the first current received through the first node and the resistance value thereof; and
a second load circuit generating a reference voltage determined by the second current received through the second node and the resistance value thereof.

2. The band gap reference circuit according to claim 1, wherein the comparator comprises an amplifier amplifying the voltage difference between the first voltage and the second voltage and outputting the amplified voltage as the control voltage.

3. The band gap reference circuit according to claim 1, wherein the second current is identical with the first current.

4. The ban gap reference circuit according to claim 1, wherein the first load circuit comprises:
a first resistance connected between the first node and a third node;
a second resistance connected between the first node and a fourth node;
a third resistance connected between the third node and a ground terminal;
a fourth resistance connected between the fourth node and the ground terminal;
a fifth resistance connected to the fourth node in parallel to the fourth resistance;
a first transistor connected between the third node and the ground terminal in parallel to the third resistance and operated in response to the ground voltage; and
a plurality of second transistors connected between the fifth resistance and the ground terminal in parallel to each other and operated in response to the ground voltage.

5. The band gap reference circuit according to claim 4, wherein each of the first and second transistors comprises a bipolar junction transistor.

6. The band gap reference circuit according to claim 4, wherein the resistance values of the first and second resistances are set so as to be identical.

7. The band gap reference circuit according to claim 4, wherein the resistance values of the third and fourth resistances are set so as to be identical.

8. The band gap reference circuit according to claim 4, wherein the resistance value of the fourth resistance is higher than the resistance value of the fifth resistance.

9. The band gap reference circuit according to claim 4, wherein the first current is the sum of a third current flowing through the first resistance and a fourth current flowing through the second resistance, the third current is the sum of a fifth current flowing through the third resistance and a six current flowing through the first transistor, and the fourth current is the sum of a seventh current flowing through the fourth resistance and an eighth current flowing through the fifth resistance.

10. The band gap reference circuit according to claim 9, wherein when the first current source circuit supplies the first current to the first node, the first voltage determined by the fifth current and the resistance value of the third resistance is generated in the third node and the second voltage determined by the seventh current and the resistance value of the fourth resistance is generated in the fourth node.

11. The band gap reference circuit according to claim 4, wherein the second load circuit comprises a sixth resistance connected between the second node and the ground terminal and the reference voltage is determined by the second current and the resistance value of the sixth resistance.

12. The band gap reference circuit according to claim 11, wherein the resistance value of the sixth resistance is higher than the resistance value of the fourth resistance.

13. A low voltage semiconductor device comprising:
a band gap reference circuit generating a reference voltage insensitive to a temperature change on the basis of a power source voltage;
an interior voltage generator generating an interior voltage on the basis of the reference voltage; and
an interior circuit using the interior voltage as an operation power source and operated when the interior voltage is supplied,
wherein the band gap reference circuit comprises:
a comparator comparing a first voltage and a second voltage and outputting a control voltage according to the comparison result;
a first current source circuit supplying a first current to a first node in response to the control voltage;
a second current source circuit supplying a second current to a second node in response to the control voltage;
a first load circuit generating first and second voltages determined by the first current received through the first node and the resistance value thereof; and
a second load circuit generating a reference voltage determined by the second current received through the second node and the resistance value thereof.

14. The low voltage semiconductor device according to claim 13, wherein the interior voltage generator generates the interior voltage identical with or different from the reference voltage.

15. The low voltage semiconductor device according to claim 13, wherein the comparator comprises an amplifier amplifying the voltage difference between the first voltage and the second voltage and outputting the amplified voltage as the control voltage.

16. The low voltage semiconductor device according to claim 13, wherein the second current is identical with the first current.

17. The low voltage semiconductor device according to claim 13, wherein the first load circuit comprises:
a first resistance connected between the first node and a third node;
a second resistance connected between the first node and a fourth node;
a third resistance connected between the third node and a ground terminal;
a fourth resistance connected between the fourth node and the ground terminal;
a fifth resistance connected to the fourth node in parallel to the fourth resistance;
a first transistor connected between the third node and the ground terminal in parallel to the third resistance and operated in response to the ground voltage; and
a plurality of second transistors connected between the fifth resistance and the ground terminal in parallel to each other and operated in response to the ground voltage.

18. The low voltage semiconductor device according to claim 17, wherein each of the first and second transistors comprises a bipolar junction transistor.

19. The low voltage semiconductor device according to claim 17, wherein the resistance values of the first and second resistances are set so as to be identical.

20. The low voltage semiconductor device according to claim 17, wherein the resistance values of the third and fourth resistances are set so as to be identical.

21. The low voltage semiconductor device according to claim 17, wherein the resistance value of the fourth resistance is higher than the resistance value of the fifth resistance.

22. The low voltage semiconductor device according to claim 17, wherein the first current is the sum of a third current flowing through the first resistance and a fourth current flowing through the second resistance, the third current is the sum of a fifth current flowing through the third resistance and a six current flowing through the first transistor, and the fourth current is the sum of a seventh current flowing through the fourth resistance and an eighth current flowing through the fifth resistance.

23. The low voltage semiconductor device according to claim 22, wherein when the first current source circuit supplies the first current to the first node, the first voltage determined by the fifth current and the resistance value of the third resistance is generated in the third node and the second voltage determined by the seventh current and the resistance value of the fourth resistance is generated in the fourth node.

24. The low voltage semiconductor device according to claim 17, wherein the second load circuit comprises a sixth resistance connected between the second node and the ground terminal and the reference voltage is determined by the second current and the resistance value of the sixth resistance.

25. The band gap reference circuit according to claim 24, wherein the resistance value of the sixth resistance is higher than the resistance value of the fourth resistance.

26. A low voltage semiconductor device comprising:
a band gap reference circuit generating a reference voltage insensitive to a temperature change on the basis of a power source voltage;
an interior voltage generator generating an interior voltage;
a detector detecting whether the interior voltage is different from the reference voltage and outputting a detection signal according to the detection result; and
an interior circuit using the interior voltage as an operation power source and operated when the interior voltage is supplied,
wherein the interior voltage generator increases or decreases the interior voltage according to the detection signal, and
the band gap reference circuit comprises:
a comparator comparing a first voltage and a second voltage and outputting a control voltage according to the comparison result;
a first current source circuit supplying a first current to a first node in response to the control voltage;
a second current source circuit supplying a second current to a second node in response to the control voltage;
a first load circuit generating first and second voltages determined by the first current received through the first node and the resistance value thereof; and
a second load circuit generating a reference voltage determined by the second current received through the second node and the resistance value thereof.

27. The low voltage semiconductor device according to claim 26, wherein the first load circuit comprises:
a first resistance connected between the first node and a third node;
a second resistance connected between the first node and a fourth node;
a third resistance connected between the third node and a ground terminal;
a fourth resistance connected between the fourth node and the ground terminal;
a fifth resistance connected to the fourth node in parallel to the fourth resistance;
a first transistor connected between the third node and the ground terminal in parallel to the third resistance and operated in response to a ground voltage; and
a plurality of second transistors connected between the fifth resistance and the ground terminal in parallel to each other and operated in response to the ground voltage.

28. The low voltage semiconductor device according to claim 27, wherein each of the first and second transistors comprises a bipolar junction transistor.

29. The low voltage semiconductor device according to claim 27, wherein the first current is the sum of a third current flowing through the first resistance and a fourth current flowing through the second resistance, the third current is the sum of a fifth current flowing through the third resistance and a six current flowing through the first transistor, and the fourth current is the sum of a seventh current flowing through the fourth resistance and an eighth current flowing through the fifth resistance.

30. The low voltage semiconductor device according to claim 29, wherein when the first current source circuit supplies the first current to the first node, the first voltage determined by the fifth current and the resistance value of the third resistance is generated in the third node and the second voltage determined by the seventh current and the resistance value of the fourth resistance is generated in the fourth node.

31. The low voltage semiconductor device according to claim 27, wherein the second load circuit comprises a sixth resistance connected between the second node and the ground terminal and the reference voltage is determined by the second current and the resistance value of the sixth resistance.

32. The band gap reference circuit according to claim 31, wherein the resistance value of the sixth resistance is higher than the resistance value of the fourth resistance.
